(19) United States
(12) Patent Application Publication
(10) Pub. No.: US 2008/0181054 A1
(43) Pub. Date: Jul. 31, 2008

(54) FLUID MIXER

(75) Inventor: Hisao KOJIMA, Yokohama-shi (JP)

Correspondence Address: DITTHAVONG MORI & STEINER, P.C., 918 Prince St., Alexandria, VA, 22314, US

(73) Assignee: Anemos Company Ltd., Tokyo (JP)

(21) Appl. No.: 11/939,457

(22) Filed: Nov. 13, 2007

(30) Foreign Application Priority Data
Jan. 29, 2007 (JP) 2007-18377

(51) Int. Cl. B01F 13/00

(52) U.S. Cl. 366/349

(57) ABSTRACT

Disclosed is a fluid mixer that includes a plurality of fluid mixing units each having openings and a mixing portion arranged in a packed column. In the fluid mixer, the plurality of fluid mixing units are irregularly arranged in axial directions different from each other.

### CROSS REFERENCES TO RELATED APPLICATIONS

The present invention contains subject matter related to Japanese Patent Application JP 2007-18377 filed in the Japanese Patent Office on Jan. 29, 2007, the entire contents of which being incorporated herein by reference.

### BACKGROUND OF THE INVENTION

1. Field of the Invention

The present invention relates to a gas-liquid contact fluid mixer having packing materials packed to mix two or more fluids.

2. Description of the Related Arts

A gas-liquid contact fluid mixer using packing materials is formed by regularly or irregularly packing the packing materials in a vertical cylinder. When a liquid is introduced into the cylinder, the liquid is dispersed by the packing materials packed in the mixer, passes along the surface of the packing materials, and flows down in the cylinder as a film.

On the other hand, a gas is supplied to the cylinder from above or below and moves through a void between the packing materials.

This brings the liquid into contact with the gas near the surface of the packing materials in the cylinder to perform gas cooling, gas absorption, dust collection, distillation, or the like.

The packing material appropriately has a large surface area and causes only a small pressure loss of a fluid, for example. A Raschig ring or a Berl saddle has been used heretofore as such a packing material having these properties, for example.

Further, Japanese Unexamined Patent Application Publication No. 7-80279 discloses a fluid mixer including packing materials arranged in parallel in a packed column and formed by a plurality of thin layers each having a corrugated groove and a row of small holes as packing materials that each have a larger surface area and may have gas-liquid contact efficiency improved.

In the fluid mixer, a liquid may be uniformly distributed over all cross-sections in the column.

### SUMMARY OF THE INVENTION

Since reaction in a fluid mixer is contact reaction between a gas and a liquid on the surface of a packing material as a gas-liquid contact portion, a surface area of the packing material greatly affects a capacity of the fluid mixer.

Therefore, it is necessary to increase the surface area of the packing material as much as possible in order to provide the fluid mixer with a high capacity.

However, when a conventional packing material has a too large surface area in order to improve gas-liquid contact efficiency, the material may have a gas-liquid contact interfacial area ensured, but a pressure loss of a fluid is inevitably increased because circulation of the fluid is prevented.

When a flow rate of a gas or liquid is increased in order to improve gas-liquid contact efficiency, a pressure loss by the packing material is increased. Further, flooding occurs so that a fluid mixer may not be stably operated.

Therefore, it is difficult to improve gas-liquid contact efficiency in a conventional fluid mixer.

According to embodiments of the present invention, there is provided a fluid mixer in which contact reaction between different fluids is efficiently performed by efficiently mixing the fluids.

The fluid mixer of an embodiment according to the present invention is a fluid mixer including a plurality of fluid mixing units each having openings and a mixing portion arranged in a packed column, where the plurality of fluid mixing units are irregularly arranged in axial directions different from each other.

The fluid mixer of an embodiment according to the present invention is also a fluid mixer including a plurality of fluid mixing units each having openings and a mixing portion arranged in a packed column, where the plurality of fluid mixing units are regularly and adjacently arranged in an axial direction perpendicular to a diameter of the packed column.

The fluid mixer of an embodiment according to the present invention is a fluid mixer including a plurality of fluid mixing units each having openings and a mixing portion arranged in a packed column, where the plurality of fluid mixing units are adjacently arranged in a direction perpendicular to a direction of a fluid flowing in the packed column to form a fluid mixing unit group, and multiple layers of the fluid mixing unit group are arranged in the direction of the fluid flowing in the packed column.

The fluid mixer of an embodiment according to the present invention includes a fluid mixing unit having a mixing portion as a packing material. Since a gas and a liquid circulated in the fluid mixer are mixed in the mixing portion of the fluid mixing unit, contact reaction occurs not only on the surface of the packing material but also by the gas and the liquid mixed by passing through the fluid mixing unit.

Accordingly, since a gas may be brought into contact with a liquid irrespective to a surface area of the packing material, gas-liquid contact may be efficiently performed.

According to the fluid mixer of an embodiment of the present invention, gas-liquid contact is efficiently performed, so that contact reaction between a gas and a liquid may be efficiently performed.

### BRIEF DESCRIPTION OF THE DRAWINGS

FIG. 1 is an oblique cross-sectional view showing a fluid mixer according to a first embodiment of the present invention.

FIGS. 2A and 2B are oblique views each showing a fluid mixing unit packed in a fluid mixer.

FIGS. 3A to 3B are plan views each showing a fluid mixing unit packed in a fluid mixer.

FIG. 4 is an oblique cross-sectional view showing a fluid mixer according to a second embodiment of the present invention.

FIG. 5 is an oblique cross-sectional view showing a fluid mixer according to a third embodiment of the present invention.

FIG. 6 is a schematic view showing a fluid mixing apparatus using a fluid mixer.

FIG. 7 is a schematic view showing a state of a fluid mixer in a fluid mixing apparatus.

FIG. 8 is a schematic view showing a state of a fluid mixer in a fluid mixing apparatus.

FIG. 9 is a schematic view showing a state of a fluid mixer in a fluid mixing apparatus.

FIG. 10 is a block diagram of a countercurrent contact fluid mixing apparatus used in examples.

FIG. 11 is a block diagram of a cocurrent contact fluid mixing apparatus used in examples.

### DESCRIPTION OF THE PREFERRED EMBODIMENTS

Specific embodiments of the present invention will be described below with reference to the drawings.

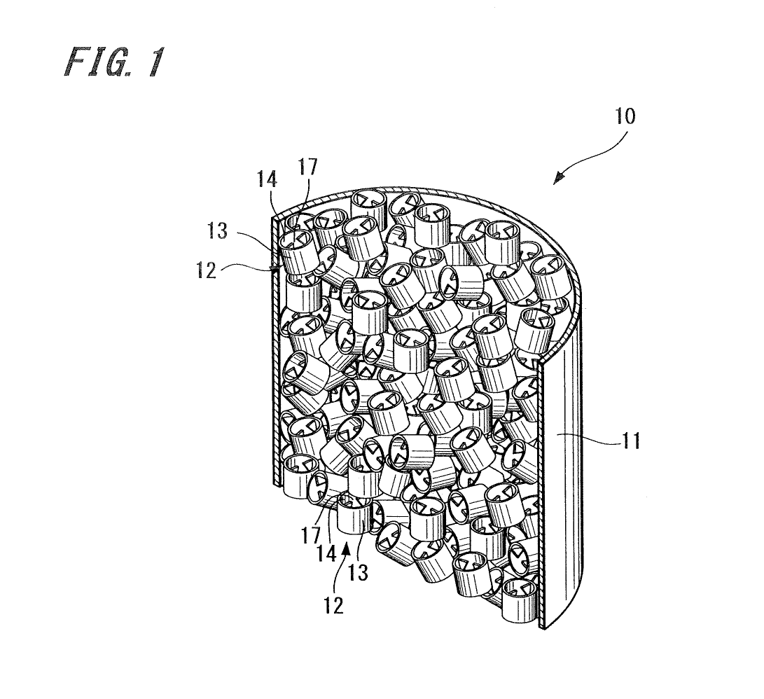

FIG. 1 is an oblique cross-sectional view of a fluid mixer according to a first embodiment of the present invention.

The fluid mixer 10 is formed by a packed column 11 and fluid mixing units 12 packed in the packed column 11.

The packed column 11 is formed by a cylindrical member in which a fluid may be circulated.

The plurality of fluid mixing units 12 are irregularly packed as packing materials in the packed column 11 in axial directions different from each other.

The fluid mixing units 12 packed in the packed column 11 each have openings 14 and a fluid mixing portion 17 provided.

The openings 14 are provided at both ends of a cylindrical passage tube 13 forming the fluid mixing unit 12. The mixing portion 17 is formed in the passage tube 13.

The fluid mixer 10 shown in FIG. 1 may be formed by placing a grid plate or the like in the cylinder of the packed column 11 and irregularly packing a necessary amount of the fluid mixing units 12 in the packed column 11 from above the packed column 11, for example.

The fluid mixer has a length in a diameter direction of about 200 mm to 2,000 mm according to need, for example.

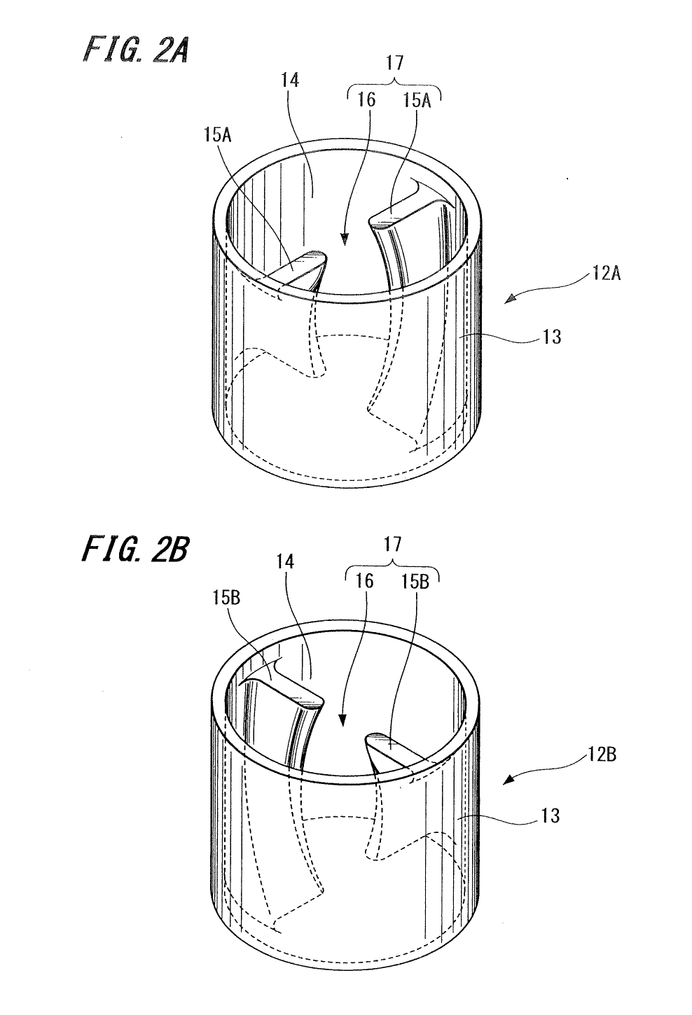

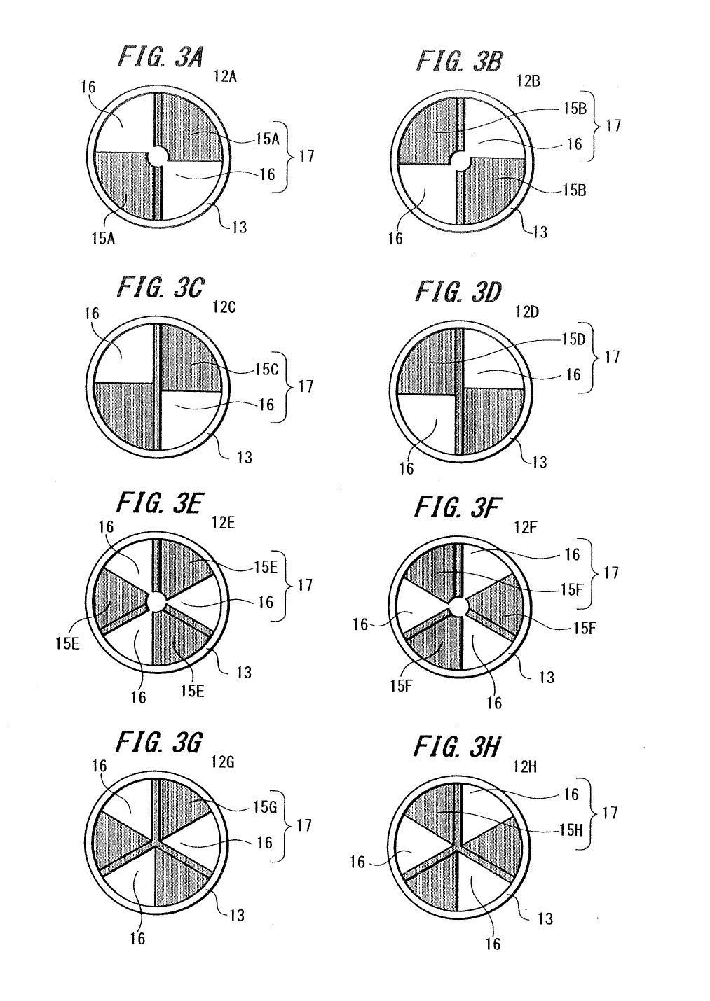

Next, the fluid mixing unit 12 packed in the fluid mixer 10 will be described with reference to FIGS. 2A and 2B and FIGS. 3A to 3H. FIGS. 2A and 2B are oblique views each showing an example of the fluid mixing unit 12 packed in the fluid mixer 10, and FIGS. 3A to 3B are plan views each showing an example of the fluid mixing unit 12.

The fluid mixing unit 12 packed in the fluid mixer 10 is formed in eight different forms as shown in FIGS. 3A to 3H.

Fluid mixing units 12A and 12B shown in FIGS. 2A and 2B are respectively formed by the openings 14 and the mixing portion 17.

The openings 14 are provided at both ends of the cylindrical passage tube 13 forming the fluid mixing unit 12A or 12B. The mixing portion 17 is formed by spiral blades 15A or 15B and a fluid passage 16 formed in the passage tube 13.

The blades 15A or 15B of the fluid mixing unit 12A or 12B shown in FIG. 2A or 2B are formed by two blades provided at an interval of about 180° on the inner wall of the passage tube 13.

The blades 15A of the fluid mixing unit 12A shown in FIG. 2A are formed twisted clockwise (rightward) at about 90° from one end to the other end in the longitudinal direction of the passage tube 13.

The blades 15B of the fluid mixing unit 12B shown in FIG. 2B are formed twisted counterclockwise (leftward) at about 90°.

The blades 15A or 15B twisted clockwise or counterclockwise are separated in two in the center of the passage tube 13. The blades 15A or 15B are separated in two, so that the fluid passage 16 communicating along the full length of the passage pipe 13 is formed through the openings 14.

Next, FIG. 3A is a plan view of the fluid mixing unit 12A shown in FIG. 2A, and FIG. 3B is a plan view of the fluid mixing unit 12B shown in FIG. 2B.

In fluid mixing units 12C to 12H shown in FIGS. 3C to 3H, the blades 15A or 15B of the fluid mixing unit 12A or 12B are formed by blades 15C to 15H in different forms.

In FIGS. 3A to 3H, the opening 14 of the fluid mixing unit of which symbol and description are omitted is formed in the same manner as in the fluid mixing unit 12A or 12B shown in FIG. 2A or 2B.

The blade 15C or 15D of the fluid mixing unit 12C or 12D shown in FIG. 3C or 3D is integrally formed as one blade in the inner wall of the passage tube 13.

The blade 15C of the fluid mixing unit 12C shown in FIG. 3C is formed twisted clockwise (rightward) at about 90° from one end to the other end in the longitudinal direction of the passage tube 13.

The blade 15D of the fluid mixing unit 12D shown in FIG. 3D is formed twisted counterclockwise (leftward) at about 90°.

The blade 15C or 15D twisted clockwise or counterclockwise is integrally formed in the passage tube 13, so that the two separate fluid passages 16 are formed by the blade 15C or 15D.

The blades 15E or 15F of the fluid mixing unit 12E or 12F shown in FIG. 3E or 3F are formed by three blades provided at an interval of about 120° each on the inner wall of the passage tube 13 and separated in three in the center of the passage tube 13.

The blades 15E of the fluid mixing unit 12E shown in FIG. 3E are formed twisted clockwise (rightward) at about 60° from one end to the other end in the longitudinal direction of the passage tube 13.

The blades 15F of the fluid mixing unit 12F shown in FIG. 3F are formed twisted counterclockwise (leftward) at about 60°.

The blades 15E or 15F twisted clockwise or counterclockwise are separated in three in the center of the passage tube 13, so that the fluid passage 16 communicating along the full length of the passage pipe 13 is formed through the openings 14.

The blade 15G or 15H of the fluid mixing unit 12G or 12H shown in FIG. 3G or 3H is formed by three blades provided at an interval of about 120° each on the inner wall of the passage tube 13 and integrally formed in the center of the passage tube 13.

The blade 15G of the fluid mixing unit 12G shown in FIG. 3G is formed twisted clockwise (rightward) at about 60° from one end to the other end in the longitudinal direction of the passage tube 13.

The blade 15H of the fluid mixing unit 12H shown in FIG. 3H is formed twisted counterclockwise (leftward) at 60°.

The blade 15G or 15H twisted clockwise or counterclockwise is integrally formed in the passage tube 13, so that the three separate fluid passages 16 are formed in the passage tube 13.

Two different types of fluids (a gas and a liquid, for example) are caused to flow countercurrently or cocurrently in the mixing portion 17 of the fluid mixing unit 12, so that a part of the fluids is spirally rotated along the blade 15 to form a rightward or leftward spiral flow. Different fluids are mixed and stirred in this manner.

A part of the fluids is sheared by the blade 15 and finely divided into multiple portions.

The fluids pass through the mixing portion 17 of the fluid mixing unit 12 in this manner, so that the fluids are repeatedly rotated, sheared, and divided in the mixing portion 17 and the two types of fluids are mixed, stirred, and efficiently brought into contact with each other.

As described above, fluids flowing in the fluid mixing unit 12 of the present embodiment may be efficiently brought into contact with each other in the mixing portion 17.

When the packing material having such a property is used, a gas-liquid contact interfacial area is increased and different fluids may be mixed, for example, based on the property of the fluid mixing unit 12 itself, so that fluids may be efficiently brought into contact with each other.

Therefore, when the fluid mixing unit 12 is used as a packing material for the fluid mixer, fluids are mixed to promote contact reaction such as dissolution or absorption of a gas in a liquid by gas-liquid contact.

Further, since the fluid mixing unit 12 has the fluid passage 16 through which a fluid may pass, a pressure loss may be reduced.

Therefore, power and maintenance costs may be reduced, a gas flow rate in an apparatus (superficial gas velocity) may be increased, and the fluid mixer 10 may be reduced in size.

It is possible to freely select the fluid mixing unit 12 used in the fluid mixer 10. For example, the fluid mixer 10 may be formed using fluid mixing units having an identical shape among the fluid mixing units 12A to 12H. Alternatively, the fluid mixer 10 may be formed using multiple types of the fluid mixing units 12 having different shapes at the same time.

Here, when the fluid mixing units 12A, 12C, 12E, or 12G having the blades 15 twisted clockwise (rightward) are used in combination with the fluid mixing units 12B, 12D, 12F, or 12H having the blades 15 twisted counterclockwise (leftward), different fluids may be efficiently mixed, for example, and fluid contact efficiency may be improved.

The fluid mixing unit 12 may be freely designed to have a width in a diameter direction and a length in an axial direction of the passage pipe 13, an area of the opening 14, and a width in a diameter direction and a length in an axial direction of the blades 15A to 15H, for example, according to the intended use.

A twisting angle of the blades 15A to 15H is not limited to about 90° and may be freely set to any angle such as about 45°, about 60°, or about 180°.

However, the fluid mixing units 12A to 12D may not be produced by injection molding when a twisting angle is more than 90°, and the fluid mixing units 12E to 12H may not be produced by injection molding when a twisting angle is more than 60°. Therefore, a twisting angle of the blades 15A to 15H is preferably about 90° or less in the fluid mixing units 12A to 12D or about 60° or less in the fluid mixing units 12E to 12H.

The fluid mixing unit 12 is made of a metal material such as stainless steel, titanium, iron, or copper, a plastic material, a ceramic material, or a composite material of these materials, and may be easily produced by injection molding, extrusion molding, lost wax casting, metal plastic forming, powder molding, or the like.

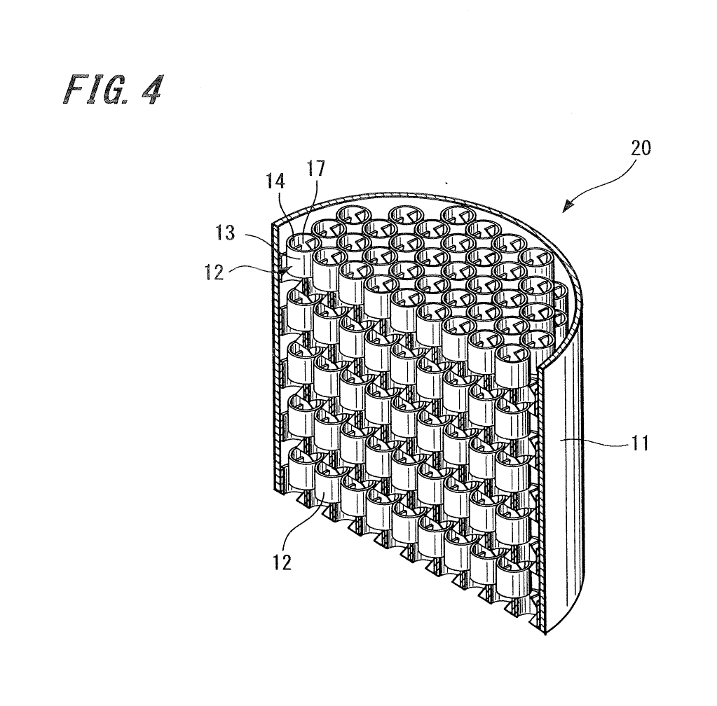

Next, FIG. 4 shows an oblique cross-sectional view of a fluid mixer 20 according to a second embodiment of the present invention.

FIG. 4 shows a state of the fluid mixer 20 where fluid mixing units 12 are packed in the fluid mixer 10 shown in FIG. 1 in a different way.

The configuration of the fluid mixer 20 shown in FIG. 4 except the method for packing the fluid mixing units 12 and the fluid mixing units 12 packed in the fluid mixer is the same as in the fluid mixer 10 shown in FIG. 1; description of the configuration is omitted by attaching the same reference symbols.

While the fluid mixing units 12 are irregularly arranged in the fluid mixer 10 shown in FIG. 1, the fluid mixing units 12 are regularly and adjacently arranged in the fluid mixer 20 shown in FIG. 4 in an axial direction perpendicular to a diameter of a packed column 11 to form a planar fluid mixing unit group.

The fluid mixing units 12 are arranged in the fluid mixer 20 with a longitudinal direction of the fluid mixing units 12 vertical. Specifically, openings 14 of the fluid mixing units 12 are placed in a direction of a fluid flowing in the fluid mixer 20.

Multiple layers of the layered fluid mixing unit group are stacked and arranged to pack the fluid mixing units 12 in the fluid mixer 20. Here, the layers of the fluid mixing units 12 are stacked so that positions of the openings 14 in an upper adjacent layer deviate from those in a lower adjacent layer.

Accordingly, the number of the fluid mixing units 12 differs between an upper adjacent layer of the fluid mixing unit group and a lower adjacent layer of the fluid mixing unit group.

In the fluid mixer 20 shown in FIG. 4, the fluid mixing units 12 are made adjacent, stacked, and regularly packed with an axial direction of the fluid mixing units 12 vertical.

When the outer walls of passage tubes 13 of the plurality of fluid mixing units 12 are connected to each other, the fluid mixing units 12 form the fluid mixing unit group having the fluid mixing units 12 planarly arranged.

The planar fluid mixing unit groups are stacked so that positions of the openings 14 of the fluid mixing units 12 in an upper adjacent group deviate from those in a lower adjacent group to form multiple layers of the fluid mixing unit group.

The fluid mixer 20 having the fluid mixing units 12 regularly packed does not prevent circulation of a fluid passing through the fluid mixer, unlike the fluid mixer 10 shown in FIG. 1 having the fluid mixing units 12 irregularly packed. This is because the fluid mixer 20 is formed by placing the fluid mixing units 12 through which a fluid may pass, so that the openings 14 and the fluid passages 16 are in a flow direction of the fluid.

Therefore, a pressure loss of a fluid may be reduced in the fluid mixer, power and maintenance costs may be reduced, a gas flow rate in an apparatus (superficial gas velocity) may be increased, and the fluid mixer may be reduced in size.

In the fluid mixer 20, since the fluid mixing unit groups are stacked so that positions of the openings 14 in an upper adjacent group deviate from those in a lower adjacent group, even a fluid having passed through a void between the fluid mixing units 12 in one layer may pass through the fluid mixing units 12 in a different layer.

Therefore, fluids are mixed in the fluid mixing units 12, and fluid contact efficiency may be improved.

The fluid mixing unit 12 used in the fluid mixer 20 may have a shape appropriately selected. For example, the fluid mixer 20 may be formed using the fluid mixing units 12 having an identical shape. Alternatively, the fluid mixer 20 may be formed using multiple types of the fluid mixing units 12 having different shapes at the same time.

Blades 15 provided in the fluid mixing units 12 may have an identical shape or different shapes.

When the fluid mixing units 12 having the blades 15 twisted in different directions are used in combination, different fluids may be efficiently mixed, for example, and fluid contact efficiency may be improved.

The fluid mixer 20 shown in FIG. 4 is formed by multiple layers of the fluid mixing unit group in which the number of the fluid mixing units 12 forming the fluid mixing unit group differs between the layers. However, when positions of the openings 14 of the fluid mixing units 12 in an upper adjacent layer deviate from those in a lower adjacent layer, the number of the fluid mixing units 12 forming the fluid mixing unit group may be equal for each layer.

In this case, it is preferable to design the number of the fluid mixing units 12 of each layer forming the layered fluid mixing unit group so that the fluid mixing units 12 may be densely packed in the fluid mixer 20.

In the fluid mixer 20 shown in FIG. 4, the outer walls of the passage tubes 13 of the fluid mixing units 12 are caused to adhere to each other according to a cross-sectional area of the packed column 11 to form the plurality of layered fluid mixing unit groups, for example. The layered fluid mixing unit groups are placed on a grid plate (not shown) in the packed column 11 and stacked to a predetermined to height, so that the fluid mixer 20 may be formed.

Alternatively, the layered fluid mixing unit group may be formed by preparing a fixing plate having holes each corresponding to a diameter of the fluid mixing unit 12 and inserting the fluid mixing units 12 into the fixing plate, for example.

The fluid mixing units 12 may be packed in the fluid mixer 20 by stacking and arranging multiple layers of the layered fluid mixing unit group together with the fixing plate to a predetermined height. Further, the fluid mixing units 12 may be packed with edges of the passage tubes 13 joined to each other.

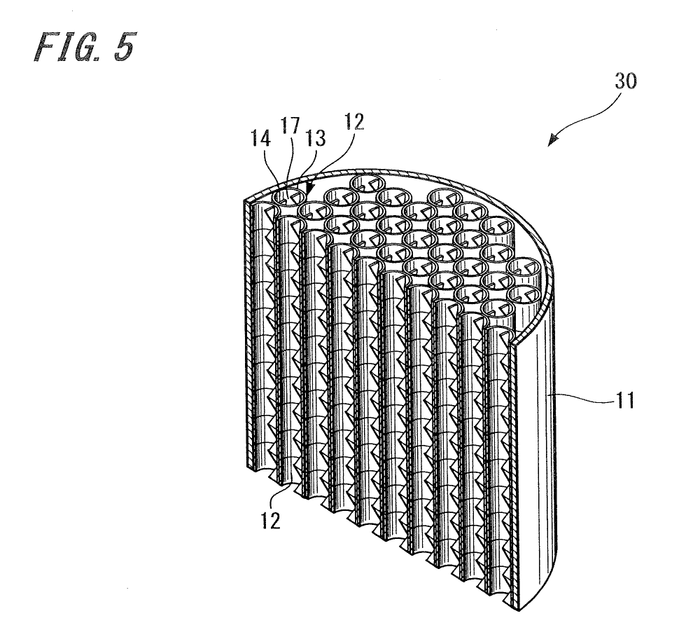

Next, FIG. 5 shows an oblique cross-sectional view of a fluid mixer 30 according to a third embodiment of the present invention.

FIG. 5 shows a state of the fluid mixer 30 in which fluid mixing units 12 are regularly packed in a different way from the fluid mixer 20 shown in FIG. 4.

The configuration of the fluid mixer 30 shown in FIG. 5 except the method for packing the fluid mixing units 12 and the fluid mixing units 12 packed in the fluid mixer is the same as in the fluid mixers 10 and 20 shown in FIGS. 1 and 4; description of the configuration is omitted by attaching the same reference symbols.

The fluid mixer 30 shown in FIG. 5 has the fluid mixing units 12 regularly packed, as in the fluid mixer 20 shown in FIG. 4.

The fluid mixing units 12 are longitudinally linked by connecting edges of passage pipes 13 to each other so that openings 14 are aligned with each other. Accordingly, the openings 14 and fluid passages 16 of the plurality of fluid mixing units 12 communicate each other to form a cylindrical fluid mixing unit group. The cylindrical fluid mixing unit groups are regularly and adjacently arranged in an axial direction perpendicular to a diameter of a packed column 11.

Multiple cylinders of the fluid mixing unit group are arranged to pack the fluid mixing units 12 in the fluid mixer 30.

In the cylindrical fluid mixing unit group used in the fluid mixer 30, since the openings 14 of the fluid mixing units 12 are connected to each other, a fluid passes through the fluid mixing units 12 and the fluid mixing unit group from the openings 14 of the uppermost or lowermost fluid mixing unit 12. Therefore, fluids may be continuously mixed in mixing portions 17 and the openings 14 of the fluid mixing units 12 and contact efficiency may be improved.

Since the fluid mixing units 12 communicate to each other having the fluid passages 16 through which a fluid may pass, circulation of a fluid passing through the fluid mixing units 12 is not prevented unlike a case where the fluid mixing units 12 are irregularly arranged.

Therefore, a pressure loss of a fluid may be reduced in the fluid mixer, power and maintenance costs may be reduced, a gas flow rate in an apparatus (superficial gas velocity) may be increased, and the fluid mixer may be reduced in size.

The cylindrical fluid mixing unit group may be formed in the fluid mixer 30 using the fluid mixing units 12 having an identical shape or using multiple types of the fluid mixing units 12 having different shapes at the same time.

Blades provided in the fluid mixing units 12 may be in an identical direction or in different directions.

When the fluid mixing units 12 having the blades 15 twisted in different directions are used in combination, different fluids may be efficiently mixed, for example, and fluid contact efficiency may be improved.

In the fluid mixer 30 shown in FIG. 5, the openings 14 of the fluid mixing units 12 are aligned with each other and edges of the passage tubes 13 are caused to longitudinally adhere to each other to form the plurality of cylindrical fluid mixing unit groups having a predetermined height, for example. The cylindrical fluid mixing unit groups are adjacently arranged on a grid plate (not shown) in a packed column 11, so that the fluid mixer 30 may be formed.

Alternatively, the layered fluid mixing unit group may be formed by preparing a fixing plate having holes each corresponding to a diameter of the fluid mixing unit 12 and inserting the fluid mixing units 12 into the fixing plate, for example.

Then, the fluid mixing units 12 may be packed in the fluid mixer 30 by stacking and arranging multiple layers of the fluid mixing unit group together with the fixing plate to a predetermined height, so that the openings 14 of the fluid mixing units 12 are aligned with each other in upper and lower adjacent layers.

When the multiple layers are stacked using the fixing plate, a void between the adjacent fluid mixing units 12 may be filled with the fixing plate in the fluid mixer 30.

Therefore, a fluid supplied to the fluid mixer 30 does not pass through the void between the fluid mixing units 12 and passes through the fluid mixing units 12, so that fluid contact efficiency may be improved.

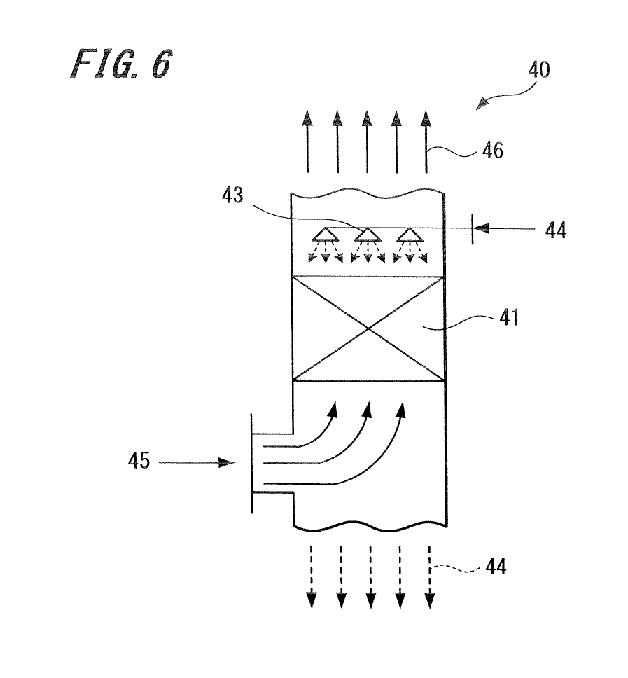

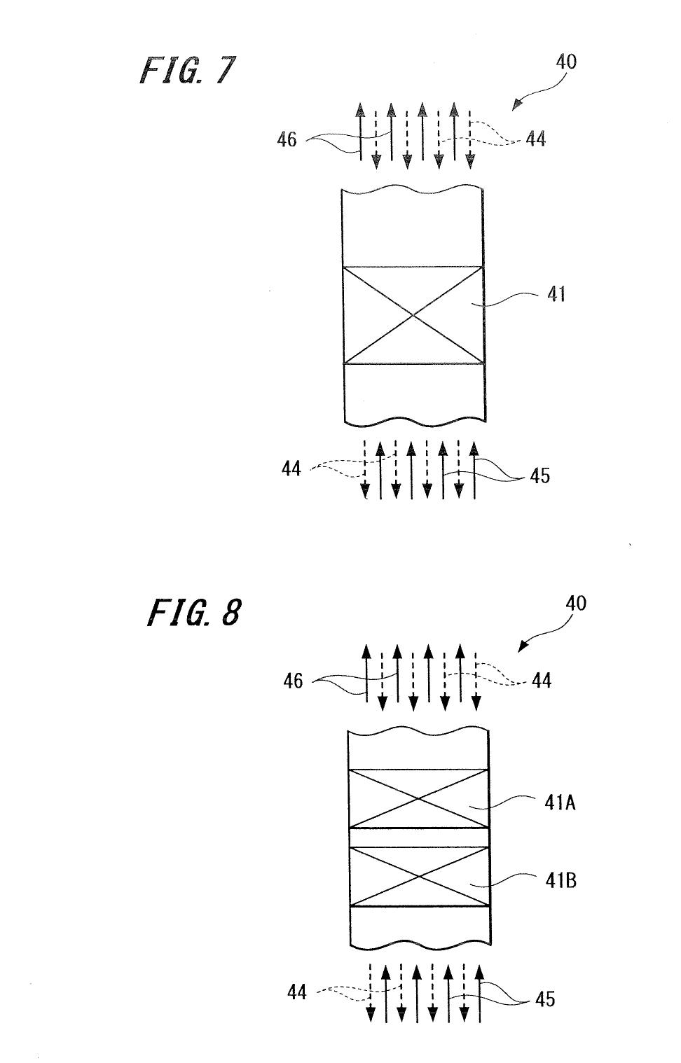

Next, FIGS. 6 and 7 show schematic views of an example of a fluid mixing apparatus that includes the fluid mixer of an embodiment according to the present invention and is used for contact reaction between a gas and a liquid.

FIG. 6 is a schematic view of a fluid mixing apparatus 40 in which a fluid mixer 41 is used for gas-liquid contact, and FIG. 7 is a schematic view showing the fluid mixer 41 in the fluid mixing apparatus 40.

In FIGS. 6 and 7, a dotted arrow indicates a flow of a liquid, and a solid arrow indicates a flow of a gas.

The fluid mixing apparatus 40 shown in FIG. 6 has the fluid mixer 41 provided formed by a packed column 11 and fluid mixing units 12 (see FIG. 1).

In the fluid mixing apparatus 40, an absorbent 44 is injected into the apparatus from a spray nozzle 43 provided in an upper part, and a raw gas 45 is supplied into the apparatus from a side of the fluid mixing apparatus 40 below the fluid mixer 41.

Contact reaction between the absorbent 44 and the raw gas 45 is performed by the action of the fluid mixer 41 when the absorbent 44 and the raw gas 45 pass through the fluid mixer 41. The absorbent 44 is discharged from a lower part of the fluid mixing apparatus 40, and the raw gas 45 is discharged from the upper part of the fluid mixing apparatus 40 as a treated gas 46.

The fluid mixing apparatus 40 may bring the raw gas 45 into contact with the absorbent 44 in the fluid mixer 41 in this manner. The fluid mixing apparatus 40 may be used for reactive absorption, physical absorption, cooling, drying, or dust removing, for example.

An absorption column, packed column, distillation column, or the like is formed by the fluid mixing apparatus 40 and the fluid mixer 41 to make it possible to perform detoxification, recovery and purification, deodorization, dust removing (dust collection), distillation and purification, and the like of exhaust gas.

Various absorbents 44 may optionally be selected. For example, it is possible to use an aqueous alkaline solution of NaOH, MgOH₂, Ca₂CO₃, or CaCl₂, an aqueous acidic solution of H₂SO₄ or HCl, tap water, sea water, or pure water.

The absorbent 44 may be selected according to a substance contained in the raw gas 45. For example, in absorption reaction, when the raw gas 45 contains an acidic gas, absorption efficiency may be improved using an aqueous alkaline solution as the absorbent 44. When the raw gas 45 contains an alkaline gas, absorption efficiency may be improved using an aqueous acidic solution as the absorbent 44.

Next, as shown in FIG. 7, the fluid mixer 41 is placed in the fluid mixing apparatus 40 by linking a packed column 11 having the same diameter as that of the fluid mixing apparatus 40 to the fluid mixing apparatus 40.

The fluid mixer 41 used here may be any of the fluid mixers 10, 20, and 30 shown in FIGS. 1, 4, and 5 in which the fluid mixing units 12 are irregularly or regularly packed.

In the fluid mixing apparatus 40, the absorbent 44 flows into the fluid mixer 41 from above the fluid mixer 41 and the raw gas 45 flows into the fluid mixer 41 from below the fluid mixer 41. Specifically, the fluid mixing apparatus 40 is a fluid mixing apparatus to perform countercurrent gas-liquid contact.

Next, an operation of the fluid mixing apparatus 40 shown in FIGS. 6 and 7 will be described.

First, the raw gas 45 as a gas for being treated in the fluid mixing apparatus 40 is supplied from a lower part of the apparatus. Then, in order to perform contact reaction of the raw gas 45 in this treatment, the absorbent 44 is supplied from an upper part of the apparatus. The raw gas 45 and the absorbent 44 are supplied to the fluid mixing apparatus 40 at a predetermined ratio.

Here, potential energy is applied to the absorbent 44 supplied from the upper part of the apparatus. The fluid to which the potential energy is applied is introduced into the fluid mixer 41 provided below. The raw gas 45 supplied from the lower part of the apparatus goes up in the apparatus and is supplied to the fluid mixer 41.

Accordingly, the raw gas 45 and the absorbent 44 are mixed and contacted in the fluid mixer 41 and sufficient gas-liquid contact is performed. Contact reaction such as separation of a substance contained in the raw gas 45, dissolution of the raw gas 45 in the absorbent 44, or progress of chemical reaction is performed based on the gas-liquid contact in the fluid mixer 41.

In this manner, in the fluid mixing apparatus 40, the absorbent 44 supplied from above the fluid mixer 41 and the raw gas 45 supplied from below the fluid mixer 41 are mixed, stirred, and contacted in the fluid mixer 41 by being divided, joined, and sheared repeatedly.

Thereafter, the raw gas 45 treated by the contact reaction is discharged or recovered from the upper part of the fluid mixing apparatus 40 as the treated gas 46. The absorbent 45 is discharged or recovered from the lower part of the fluid mixing apparatus 40.

The absorbent 44 may be supplied to the fluid mixing apparatus 40 not only by a method of spraying with a spray nozzle but also by another method.

The absorbent 44 is sprayed with a spray nozzle in the upper part of the fluid mixing apparatus 40, so that the absorbent 44 is uniformly distributed in the fluid mixer 41 and gas-liquid contact may be efficiently performed.

Next, FIG. 8 shows a schematic view of fluid mixers 41A and 41B in an example of the fluid mixing apparatus 40 shown in FIG. 6 using the fluid mixer 41 of an embodiment according to the present invention to perform contact reaction between a gas and a liquid, where the plurality of fluid mixers 41 are used.

In FIG. 8, description of the configuration identical to those of FIGS. 6 and 7 is omitted by attaching the same reference symbols.

In the fluid mixing apparatus 40 of FIG. 8, the absorbent 44 flows into the fluid mixers 41A and 41B from above the fluid mixers 41A and 41B and the raw gas 45 flows into the fluid mixers 41A and 41B from below the fluid mixers 41A and 41B. Specifically, the fluid mixing apparatus 40 is a fluid mixing apparatus to perform countercurrent gas-liquid contact.

The fluid mixers 41A and 41B are placed in the fluid mixing apparatus 40 by linking packed columns 11 each having the same diameter as that of the fluid mixing apparatus 40 to the fluid mixing apparatus 40.

The fluid mixers 41A and 41B used here may be any of the fluid mixers 10, 20, and 30 shown in FIGS. 1, 4, and 5 in which the fluid mixing units 12 are irregularly or regularly packed.

The fluid mixers 41A and 41B may have a configuration freely selected, respectively. For example, it is possible to use the fluid mixers 10, 20, or 30 having an identical configuration, or alternatively to use the fluid mixers 10, 20, or 30 having different configurations.

In the fluid mixing apparatus 40 having the two fluid mixers 41, the absorbent 44 is brought into countercurrent contact with the raw gas 45 in the fluid mixers 41A and 41B provided in different positions. Therefore, the apparatus has multiple configurations in which a gas and a liquid may be mixed and contacted, so that contact efficiency between the gas and the liquid may be improved.

The plurality of fluid mixers 41 are provided in the fluid mixing apparatus 40 in this manner, so that gas-liquid contact reaction may be efficiently performed.

A space may be provided between the fluid mixer 41A and the fluid mixer 41B. Further, a spray nozzle to supply the absorbent 44 may be provided in the space.

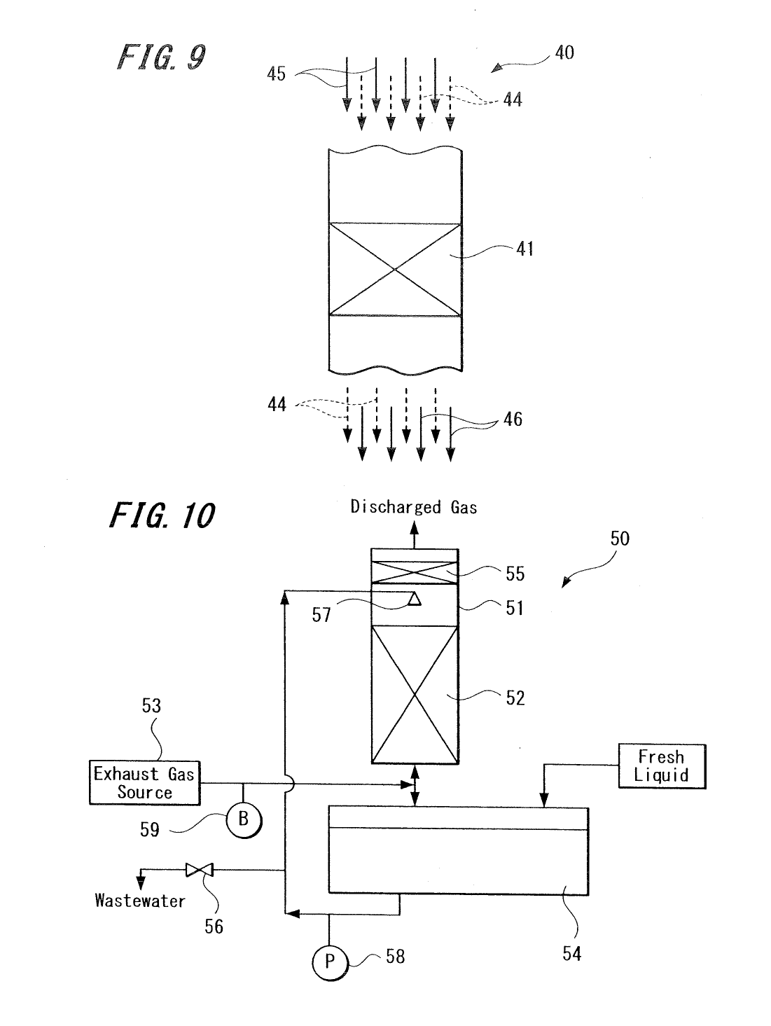

Next, FIG. 9 shows a schematic view of a fluid mixing apparatus 40 of an embodiment according to the present invention in an example of the fluid mixing apparatus 40 shown in FIG. 6 using the fluid mixer 41 to perform contact reaction between a gas and a liquid, where the gas is brought into occurrent contact with the liquid.

In FIG. 9, description of the configuration identical to those of FIGS. 6 to 8 is omitted by attaching the same reference symbols.

The fluid mixer 41 is placed in the fluid mixing apparatus 40 by linking the packed column 11 having the same diameter as that of the fluid mixing apparatus 40 to the fluid mixing apparatus 40.

The fluid mixer 41 used here may be the fluid mixer 10, 20, or 30 shown in FIG. 1, 4, or 5 in which the fluid mixing units 12 are irregularly or regularly packed.

In the fluid mixing apparatus 40, the absorbent 44 and the raw gas 45 flow into the fluid mixer 41 from above the fluid mixer 41. The aforementioned contact reaction is performed when the absorbent 44 and the raw gas 45 pass through the fluid mixer 41. The absorbent 44 and the treated gas 46 are discharged from a lower part of the fluid mixing apparatus 40.

Specifically, the fluid mixing apparatus 40 is a fluid mixing apparatus to perform occurrent gas-liquid contact.

Here, potential energy is applied to the absorbent 44 supplied from an upper part of the apparatus. The fluid to which the potential energy is applied is introduced into the fluid mixer 41 provided below while involving the gas. This causes the absorbent 44 and the raw gas 45 to pass through the fluid mixing apparatus, so that the fluids may be mixed, stirred, and contacted.

Accordingly, the raw gas 45 and the absorbent 44 are mixed and contacted in the fluid mixer 41 and sufficient gas-liquid contact is performed. Contact reaction such as separation of a substance contained in the raw gas 45, dissolution of the raw gas 45 in the absorbent 44, or progress of chemical reaction is performed based on the gas-liquid contact in the fluid mixer 41.

The fluid mixer 41 used here may be any of the fluid mixers 10, 20, and 30 shown in FIGS. 1, 4, and 5 in which the fluid mixing units 12 are irregularly or regularly packed.

In the fluid mixing apparatus 40 to perform cocurrent gas-liquid contact, a liquid is sprayed and supplied from the upper part of the apparatus to cause the liquid to pass through the fluid mixer 41 while involving a gas, so that the liquid and the gas are treated by mixing, stirring, and contacting. Therefore, the gas may be supplied and mixing, stirring, and contacting operations may be performed without a power.

Accordingly, it is not necessary to use a power device to supply a gas, and a low-cost, energy-saving fluid mixing apparatus may be formed.

Even the fluid mixing apparatus 40 to perform the cocurrent contact may be formed by providing the two fluid mixers 41 as in the fluid mixing apparatus shown in FIG. 8. The plurality of fluid mixers 41 are provided in the fluid mixing apparatus 40, so that gas-liquid contact reaction may be efficiently performed.

The fluid mixer of an embodiment according to the present invention will be described below by way of examples.

In the examples, the fluid mixer was used in a countercurrent contact fluid mixing apparatus and a cocurrent contact fluid mixing apparatus to perform experiments.

(Countercurrent Contact Fluid Mixing Apparatus)

First, the countercurrent contact fluid mixing apparatus used in the examples will be described with reference to the drawing.

FIG. 10 is a block diagram of a fluid mixing apparatus 50 used in the later-described Example 1 and Comparative Example 1. The fluid mixing apparatus 50 is a countercurrent contact fluid mixing apparatus formed by an absorption column (packed column) 51 having a fluid mixer 52; an exhaust gas source 53; an air-exhaust ventilator 59; and a circulating liquid tank 54.

Exhaust gas (raw gas) from the exhaust gas source 53 is supplied from below the absorption column (packed column) 51 having the fluid mixer 52 by an air-exhaust ventilator 59. The purified exhaust gas (treated gas) from the fluid mixing apparatus 50 is released to the atmosphere from an upper part of the absorption column (packed column) 51 through a mist separator 55.

The absorption column 51 is linked to the circulating liquid tank 54 provided below the absorption column 51.

An aqueous solution in the circulating liquid tank 54 is discharged to wastewater treatment or the like by appropriately opening a valve 56, and a fresh liquid is appropriately supplied into the circulating liquid tank 54.

A spray nozzle 57 is provided in a head part of the absorption column 51, and a liquid in the circulation liquid tank 54 is supplied to the nozzle 57 by a circulation liquid pump 58.

Accordingly, the liquid in the circulation liquid tank 54 is circularly used, where the liquid is injected to the absorption column 51 by the nozzle 57, then collected in the circulation liquid tank 54, and is subsequently supplied to the nozzle 57 by the circulation liquid pump 58.

(Cocurrent Contact Fluid Mixing Apparatus)

Next, the cocurrent contact fluid mixing apparatus used in the examples will be described with reference to the drawing.

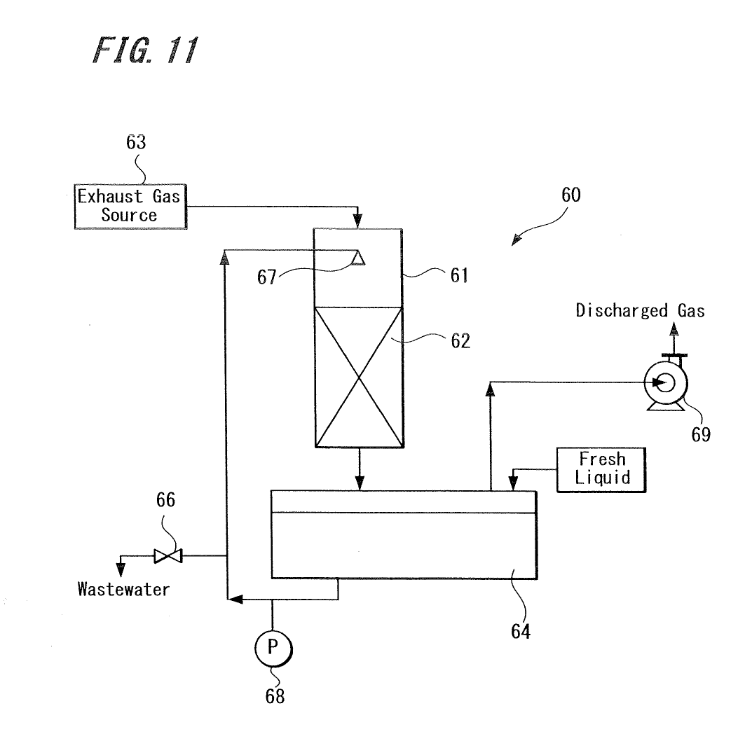

FIG. 11 is a block diagram of a fluid mixing apparatus 60 used in the later-described Examples 2 and 3. The fluid mixing apparatus 60 is a cocurrent contact fluid mixing apparatus formed by an absorption column (packed column) 61 having a fluid mixer 62; an exhaust gas source 63; an air-exhaust ventilator 69; and a circulating liquid tank 64.

Exhaust gas (raw gas) from the exhaust gas source 63 is supplied from above the absorption column (packed column) 61 having the fluid mixer 62.

The absorption column 61 is linked to the circulating liquid tank 64 provided below the absorption column 61.

The purified exhaust gas (treated gas) from the fluid mixing apparatus 60 is released to the atmosphere by an air-exhaust ventilator 69.

An aqueous solution in the circulating liquid tank 64 is discharged to a wastewater treatment process or the like by appropriately opening a valve 66, and a fresh liquid is appropriately supplied into the circulating liquid tank 64.

A spray nozzle 67 is provided in a head part of the absorption column 61, and a liquid in the circulation liquid tank 64 is supplied to the nozzle 67 by a circulation liquid pump 68.

Accordingly, the liquid in the circulation liquid tank 64 is circularly used, where the liquid is injected to the absorption column 61 by the nozzle 67, then collected in the circulation liquid tank 64, and is subsequently supplied to the nozzle 67 by the circulation liquid pump 68.

### EXAMPLE 1

The fluid mixer 52 in the countercurrent contact fluid mixing apparatus 50 was formed in the same manner as in the fluid mixer 10 shown in FIG. 1 having the fluid mixing units 12 irregularly arranged.

Two types of fluid mixing units the same as the fluid mixing units 12A and 12B shown in FIGS. 2A and 2B were mixed and packed in the fluid mixer 52. The fluid mixing unit 12A or 12B has two spirally formed blades each twisted to the right or left at about 90° and has an external diameter of 62 mm, an internal diameter of 52 mm, and a height of 40 mm.

The fluid mixing units 12A and the fluid mixing units 12B were packed in the fluid mixer 52 at a volume ratio of 50:50.

The fluid mixer of Example 1 was formed under the above conditions and used for the countercurrent contact fluid mixing apparatus 50.

### EXAMPLE 2

The fluid mixer 62 in the cocurrent contact fluid mixing apparatus 60 was formed in the same manner as in the fluid mixer 20 shown in FIG. 4 having the fluid mixing units 12 regularly arranged.

Fluid mixing units the same as the fluid mixing units 12A and 12B shown in FIGS. 2A and 2B were packed in the fluid mixer 62. The fluid mixing unit 12A or 12B has two spirally formed blades each twisted to the right or left at about 90° and has an external diameter of 62 mm, an internal diameter of 52 mm, and a height of 40 mm.

The fluid mixing units 12A and the fluid mixing units 12B were packed in the fluid mixer 52 at a volume ratio of 50:50.

The fluid mixer of Example 2 was formed under the above conditions and used for the cocurrent contact fluid mixing apparatus 60.

### EXAMPLE 3

The fluid mixer 62 in the cocurrent contact fluid mixing apparatus 60 was formed in the same manner as in the fluid mixer 30 shown in FIG. 5 having the fluid mixing units 12 regularly arranged.

Fluid mixing units the same as the fluid mixing units 12A and 12B shown in FIGS. 2A and 2B were packed in the fluid mixer 62. The fluid mixing unit 12A or 12B has two spirally formed blades each twisted to the right or left at about 90° and has an external diameter of 62 mm, an internal diameter of 52 mm, and a height of 40 mm.

The fluid mixing units 12A and the fluid mixing units 12B were packed in the fluid mixer 52 at a volume ratio of 50:50.

The fluid mixer of Example 3 was formed under the above conditions and used for the cocurrent contact fluid mixing apparatus 60.

### Comparative Example 1

The fluid mixer 52 in the countercurrent contact fluid mixing apparatus 50 had Tellerette S-type packing materials (manufactured by Tsukishima Kankyo Engineering Ltd.) irregularly packed as packing materials.

The fluid mixer of Comparative Example 1 was formed under the above conditions and used for the countercurrent contact fluid mixing apparatus 50.

Experiments of causing HCl contained in exhaust gas to be absorbed in a 3 wt % aqueous NaOH solution as a circulating liquid (absorbent) were performed in the fluid mixing apparatuses 50 and 60 in which the fluid mixers formed in Examples 1 to 3 and Comparative Example 1 were used.

For the experiments, each of the fluid mixing apparatuses 50 and 60 prepared in Examples 1 to 3 and Comparative Example 1 were designed so that the exhaust gas had an HCl gas concentration of 100 ppm in an inlet of the apparatus and 3 ppm in an outlet of the apparatus.

In the countercurrent contact fluid mixing apparatus 50, the concentration of the HCl gas contained in the exhaust gas was measured in an inlet of the air-exhaust ventilator 59. The HCl gas concentration in the treated gas after bringing the gas into countercurrent contact with the circulating liquid (absorbent) in the fluid mixing apparatus 50 was measured in an outlet of the absorption column 51.

In the cocurrent contact fluid mixing apparatus 60, the concentration of the HCl gas contained in the exhaust gas was measured in an inlet of the absorption column (packed column) 61. The HCl gas concentration in the treated gas after bringing the gas into cocurrent contact with the circulating liquid (absorbent) in the fluid mixing apparatus 60 was measured in an outlet of the air-exhaust ventilator 69.

Table 1 shows conditions for designing the absorption columns 51 and 61 and the fluid mixers 52 and 62 of Examples 1 to 3 and Comparative Example 1 prepared in the above experiments.

TABLE 1

| | | | | Comparative |
|---|---|---|---|---|
| | Example 1 | Example 2 | Example 3 | Example 1 |
| Column diameter | 300 | 360 | 280 | 450 |
| (internal diameter) (mm) | | | | |
| Packing height (mm) | 1200 | 480 | 480 | 1500 |
| Number of packed units (units/m³) | 3750 | 192 | 108 | 25000 |
| Necessary packing amount (m³) | 0.11 | 0.46 | 0.26 | 0.26 |
| Amount of treated gas (m³/min) | 10 | 10 | 10 | 10 |
| Cas velocity in column (m/s) | 2.35 | 5.0 | 9.3 | 1.05 |
| Amount of cleaning liquid (kg/h) | 3000 | 4800 | 3000 | 3200 |
| Liquid-gas ratio (L/m³) | 5.0 | 8.0 | 5.0 | 5.3 |
| Pressure loss (Pa) | 200 | 350 | 550 | 300 |
| HCl inlet concentration (ppm) | 100 | 100 | 100 | 100 |
| HCl outlet concentration (ppm) | 3 | 3 | 3 | 3 |

As shown in Table 1, the absorption column 51 and the fluid mixer 52 formed in Example 1 had a column diameter about 30% smaller than in Comparative Example 1, had a packing height about 20% smaller than in Comparative Example 1, and caused a pressure loss about 30% smaller than in Comparative Example 1; however, the same results were achieved in Example 1 and Comparative Example 1 for the HCl concentration.

According to the configuration of Example 1, a gas velocity in the column may be increased and a pressure loss may be reduced as compared with the configuration of Comparative Example 1, even if a gas flow rate is equal.

A packing height of the packing materials of the fluid mixer 62 in Examples 2 and 3 was reduced to about ⅓ based on a packing height in Example 1 and Comparative Example 1.

This is because the packing materials are regularly packed in the absorption column, so that a gas velocity in the column may be increased and gas-liquid contact may be efficiently performed.

A gas velocity in the column having the fluid mixing units regularly packed was higher in the configuration of Example 3 than in the configuration of Example 2. This is because in Example 3, the fluid mixing units used as packing materials are connected to each other with the openings aligned with each other, so that a fluid may pass through the apparatus without prevention of circulation of the fluid.

Therefore, in the configuration of Example 2 or 3, the packed column may be reduced in size and an amount of the packing materials used may be reduced.

A pressure loss is larger in Examples 2 and 3 than in Example 1 and Comparative Example 1, because a pressure loss is larger as a gas flow rate is higher. Therefore, it is assumed that a pressure loss in Examples 2 and 3 may be smaller than that in Example 1 and Comparative Example 1 when a gas velocity in the column in Examples 2 and 3 is equal to that in Example 1 and Comparative Example 1.

As described above, an energy-saving, space-saving fluid mixer having excellent fluid mixing efficiency may be formed by the configuration of Examples 1 to 3.

Further, when a countercurrent contact fluid mixer is used, flooding does not occur and treatment may be performed at a high liquid-gas ratio L/G. For example, treatment may be performed at a liquid-gas ratio of 10 L/m³ or more, and exhaust gas having an HCl gas concentration of 1 vol % or more may be easily treated.

Further, the fluid mixing units 12A to 12H may include a porous body to form a fluid mixer.

The fluid mixer including the porous body may be used for a bioreactor or a deodorization device, or the like, which support a biocatalyst such as microorganisms and enzymes.

The present invention is not limited to the above-described configuration, and various other configurations are possible without departing from the gist of the present invention.

Having described preferred embodiments of the invention with reference to the accompanying drawings, it is to be understood that the invention is not limited to those precise embodiments and that various changes and modifications could be effected therein by one skilled in the art without departing from the spirit or scope of the invention as defined in the appended claims.

What is claimed is:

1. A fluid mixer comprising a plurality of fluid mixing units each having openings and a mixing portion arranged in a packed column, wherein
the plurality of fluid mixing units are irregularly arranged in axial directions different from each other.

2. A fluid mixer comprising a plurality of fluid mixing units each having openings and a mixing portion arranged in a packed column, wherein
the plurality of fluid mixing units are regularly and adjacently arranged in an axial direction perpendicular to a diameter of the packed column.

3. A fluid mixer comprising a plurality of fluid mixing units each having openings and a mixing portion arranged in a packed column, wherein
the plurality of fluid mixing units are adjacently arranged in a direction perpendicular to a direction of a fluid flowing in the packed column to form a fluid mixing unit group, and
multiple layers of the fluid mixing unit group are arranged in the direction of the fluid flowing in the packed column.

4. The fluid mixer according to claim 3, wherein
the number of the fluid mixing units forming the fluid mixing unit group is equal for each layer.

5. The fluid mixer according to claim 3, wherein
the number of the fluid mixing units forming the fluid mixing unit group differs between adjacent layers.

6. The fluid mixer according to any one of claims 1 to 5, wherein
the fluid mixing units each have at least one spiral blade and at least one fluid passage in a cylindrical passage tube.

7. The fluid mixer according to any one of claims 1 to 6, wherein
the plurality of fluid mixing units have an identical shape.

8. The fluid mixer according to any one of claims 1 to 7, wherein the fluid mixing unit includes a porous body.
